(19) United States
(12) Patent Application Publication
(10) Pub. No.: US 2008/0280277 A1
(43) Pub. Date: Nov. 13, 2008

(54) MOTIVATIONAL COACHING TECHNIQUES TAILORED FOR INDIVIDUALS

(76) Inventor: Jeffrey Evan Fernandez, Dumont, NJ (US)

Correspondence Address: Hiscock & Barclay, LLP, One Park Place, 300 South State Street, Syracuse, NY, 13202-2078, US

(21) Appl. No.: 12/098,990

(22) Filed: Apr. 7, 2008

Related U.S. Application Data
(60) Provisional application No. 60/910,503, filed on Apr. 6, 2007.

(51) Int. Cl. G09B 19/00

(52) U.S. Cl. 434/236

(57) ABSTRACT

The present invention provides a way to determine if coaches' motivational techniques have an effect, either positive or negative, on an athlete's performance based on the athlete's personality factors. One exemplary study showed that there was significant correlation between a coach's motivational approach and at least the agreeableness of the athlete. Most athletes, especially those high in Agreeableness, achieve peak performance when exposed to the Positive Reinforcing Coaching Technique and experience increased levels of confidence; however, some athletes prefer the Demeaning Coaching Technique. Thus, an Individualized Coaching Approach is needed to effectively solicit peak performance from all athletes. Programs and methods for quickly devising such an individualized coaching approach using personality trait(s) of the athlete or any other subject are provided by the present invention.

### CROSS-REFERENCE TO RELATED APPLICATION

This application claims priority to and the benefit of U.S. Provisional Application No. 60/910,503 filed on Apr. 6, 2007, which application is incorporates herein by reference in its entirety.

### FIELD OF THE INVENTION

This invention relates to materials and methods for motivating and coaching an individual, e.g., an athlete, to perform better.

### BACKGROUND

The quality of one's athletic performance is determined by three major factors: learned behaviors, environmental variables, and genetic disposition (Lyle, 2002). Learned behaviors can be defined as skills, techniques, and approaches that an athlete discovers during specific sport training, from the guidance of knowledgeable elders, and from the scientific community. Environmental variables include pre-training music, natural conditions including the wind and rain, and mood prior to competition. Lastly, genetic disposition can be defined as athletes' genetic and biological structure that limits their speed, agility, quickness, strength, stamina, and endurance (Lyle, 2002).

Many psychologists have experimentally identified learned behaviors and environmental variables that have the capacity to improve athletic performance. Some examples include: Lane & Streeter's (2003) study that identified tangible goal setting as a learned behavior that can improve athletic performance, Thelwell & Greenlees' (2003) study that identified pre-performance and during-performance mental skills training as a learned behavior that can facilitate athletic performance, Jones' (2003) study that identified emotional strategies as learned behaviors that have the capacity to enhance athletic performance, Pates & Maynard & Westbury's (2001) study that identified hypnosis as an environmental variable that can increase the sensations associated with peak performance that ultimately develop improved athletic performance, and Pates & Karageorghis & Fryer & Maynard's (2003) study that identified self-selected background music as an environmental variable capable of increasing the likelihood of peak experience and improving athletic performance.

Surprisingly, one of the most apparent environmental variables that may influence athletic performance, a coach's motivational approach, has been inadequately researched. Both athletes and coaches are individuals with unique personalities and sets of experiences. The interaction between coaches and athletes is an environmental variable that ideally contributes to improving athletic performance but unfortunately has the capacity to hinder performance as well.

According to Gerry Callahan, sports commentator for WEEI Sports Radio in Boston and sports columnist for the Boston Herald, two specific coaching styles are prevalent today in professional sports: the “Disciplinarian Manager” and the “Players' Coach”. Callahan claimed that the Disciplinarian Manager motivates with fear: the fear of being cut, of losing one's starting role, of being out of a job. They often coach football teams and use a Demeaning Coaching Approach in an effort to solicit peak performance. Furthermore, they usually apply the Demeaning Coaching Approach to all players.

While the Demeaning Coaching Approach is successful in soliciting peak performance from some athletes, it is wholly ineffective for others. In fact, Warren (2002) argues that fearing one's coach can have negative consequences for many players. Some athletes' performances are seriously hindered by negative criticism.

Conversely, Mr. Callahan claims that, in contrast to football coaches, most baseball and basketball coaches are “Players' Coaches” because they put the needs, desires, and sometimes demands of the athletes before their own. Furthermore, Players' Coaches are very supportive, caring, and considerate of each player's needs. Thus, they often use the Positive Reinforcing Coaching Approach.

The Players' Coach attempts to motivate all athletes. While he often uses the Positive Reinforcing Coaching Approach, he also understands that some athletes thrive on praise and compliments while others believe that a compliment is a signal to reduce the intensity of one's training regimen. Thus, the Players' Coach recognizes differences among athletes and strives to tailor his motivational technique to solicit peak performance from each athlete individually.

Vince Lombardi may be the best example of a coach with the ability to tailor his coaching approach to solicit peak performance from each athlete. Lombardi was the legendary coach of Army's football program and later the coach for the Green Bay Packers (Phillips, 2001). From 1959-1968, he coached the Packers to six division titles, two Super Bowls victories, and acquired a record of 98 wins, 30 losses, and 4 ties. He was known for his demanding style, team oriented approach, attention to detail, specific selection of hard working players, and most importantly, his focus on motivating each athlete individually (Phillips, 2001).

In fact, Lombardi was capable of providing in depth commentary about each of the thirty-six Green Bay Packers. Two examples include his comments about Paul Hornung and Bart Starr. According to Lombardi, Paul Hornung “Can take criticism in public or anywhere. You have to whip him a little. He had a hell-with-you attitude, a defensive perimeter he built around himself when he didn't start out well here. As soon as he had success, he changed. Always looks you straight in the eye (Phillips, 2001, p. 56).” Lombardi claimed that Bart Starr was “Modest. Tends to be self-effacing, which is usually a sign of lack of ego. He calls me ‘sir.’ Seems shy, but he's not. He's just a gentleman. You don't criticize him much in front of others. When I came here he lacked confidence and support (Phillips, 2001, p. 56).” Vince Lombardi appeared to understand his players' personalities and attempted to solicit peak performance from each athlete individually.

Although there are coaches like Vince Lombardi and Terry Francona (Boston Red Sox manager) who provide compelling case studies of successful coaches who strive to solicit peak performance from each athlete individually, variations in coaching approaches and techniques having different effects on athletes with varying personality characteristics has not been tested empirically. Furthermore, there is no program that helps any coach or supervisor utilize any scientific linkage that may exist between coaching techniques and an athlete or trainee's individual traits.

### SUMMARY OF THE INVENTION

The present invention provides methods and materials that explore the relationship between a performer's individual trait(s), e.g., an aspect of an athlete's personality, and his reception to certain motivational and coaching techniques in order to tailor such techniques for the individual. This involves ascertaining where the individual stands in terms of certain personality traits through a questionnaire or a similar test. In other words, the present invention provides an efficient way to determine an individual's performance-affecting personality and, accordingly, what corresponding training methodology and techniques should be applied to this person in order to improve or preferably, to solicit peak performance.

In a first aspect, the present invention provides methods and materials useful in identifying traits affecting the performance at issue, especially those traits that predispose the individual positively or negatively under a particular training or motivational technique such that his performance is affected substantially. In a particular feature, one or more personality traits empirically proven to affect a group's athletic performance are provided. In a second aspect, the present invention provides methods and programs useful in correlating certain training techniques or approaches with the identified personality traits. In a third aspect, the present invention also provides methods and materials useful in fine-tuning the above programs. In one feature, a scoring system is devised to determine an individual's relative strength or weakness in one or more traits, and to modify the corresponding training methodology accordingly. In another feature, population-specific factors such as age, gender, ethnicity, race, education level, national origin, religion and sexual orientation are taken into consideration. In yet another feature, task-specific factors such as whether and how much team work the task requires is taken into consideration. Moreover, coach's personality traits and other background factors can also be factored in. In a further feature, method and materials are provided to update the training technique by evaluating changes in the same individual's trait(s) and performance. As a result, the individualized training techniques can be updated continually.

In one embodiment, the present invention provides a coaching program that includes a personality test to be taken by an individual, the test comprising questions designed to score the individual on one or more personality traits. The program also includes a table correlating at least one score from the test to a particular coaching technique as a recommendation for the individual. The personality trait being tested, in one feature, includes agreeableness. And the coaching technique is selected from the group consisting of positive reinforcement, mechanical and demeaning (or disciplinary) coaching techniques. Other personality traits for testing may include neuroticism, extraversion, openness to experience, and conscientiousness.

In one feature, the program of the present invention is designed for improving athletic performance or other kind of physical performance such as recovery under physical therapy. In another feature, the program is designed for improving job performance, including what is commonly referred to as “office” job, “corporate” job or “white-collar” job.

In one embodiment, the present invention provides a method for devising a coaching approach for an individual that includes the steps of: administering a personality test to an individual; scoring the individual on one or more personality traits; and determining, based on the individual's score on the one or more personality traits, what kind of coaching technique should be applied to motivate the individual.

Materials useful for the present invention can be in the form of any medium including those printed on a tangible medium or stored in an electronic medium, e.g., paper, pamphlet, book, questionnaire, tape, computer-readable compact disc, video cassette, DVD, and any electronic memory. This invention also provides business methods aimed at commercializing this method of tailoring training or motivational techniques based on individual's personality traits.

### BRIEF DESCRIPTION OF THE DRAWINGS

FIG. 1 is a graphic representation of findings regarding the mean pre/post free throw differences by the coaching condition/technique and the level of neuroticism according to the present invention.

FIG. 2 is a graphic representation of findings regarding the mean pre/post free throw differences by the coaching condition/technique and the level of agreeableness according to the present invention.

FIG. 3 is a graphic representation of findings regarding the effect on confidence under different coaching conditions/techniques.

### DETAILED DESCRIPTION OF THE INVENTION

In virtually all specialized activities nowadays, whether academic, recreational or professional, training is an important vehicle to impart knowledge to a trainee and to solicit better performance from him as he gains experience. This is particularly true, e.g., in service industries ranging from consulting to law, and in corporate departments such as sales and marketing. Different techniques have been applied through these training processes. An entire industry of corporate training has sprung up where motivational speakers tour the country giving speeches at corporate retreat and workshops. Many corporations also work with consultants or internal personnel in motivating its staff members, hoping for better performance. These training protocols and motivational techniques are typically provided for groups of co-workers, an entire department, all the associates or even the entire company personnel. In general, there is no effort to distinguish among the recipients of the training so that they are trained, coached, or motivated in different styles. In practice, most of the motivational speakers come from outside the corporation and do not have the time and resource to get to know the trainees to tell them apart from each other.

Further description of the present invention's individualized training approach is provided in the context of sports performance but should not be limited as such. As described in the “background” section, there are very different approaches in sports coaching: the Disciplinarian Manager tend to use the Demeaning Approach or Technique while the Players' Coach tend to try the Positive Reinforcing Approach or Technique. There are outstanding coaches who try to get to know each of their players and motivate them differently, which takes a great deal of time and patience, and depends on how good the coach is. To date, there is no systematic approach to individualize motivational techniques, in sports or outside.

Through a study described below, it is concluded that different individuals, in this case, athletes, react to different coaching or motivational techniques differently, and such different reactions can be correlated to their personality trait(s). The following study also illustrates how to identify such personality trait(s) through statistical analysis with good controls. The study provides evidence that among the five traits commonly used for personality test, agreeableness correlates most with the athlete's responsiveness to the coaching techniques tested. In fact, agreeableness may be the only variable responsible for the differences observed. Importantly, the results of this study suggest an inventive method to improve athletic performance: the Individualized Coaching Approach. By employing this approach and methods and programs derived from it, coaches can solicit peak performance from all athletes based on their individual coaching preferences. Importantly, if a coach adopts this approach, he will no longer reduce the quality of performance in a number of their athletes by blindly applying one coaching approach to all of his athletes. Instead, the coach will foster an environment conducive to athletic success for all athletes regardless of their preferences in coaching approach. And this remains true whether it is an individual sport or a team sport.

As exemplified by the following study, the Individualized Coaching Approach, in one embodiment, only requires the administration of a simple personality test to determine levels of Agreeableness as the foundation of the coach-player interaction. On one hand, by simply administering this test and determining levels of Agreeableness, a coach may quickly identify the athletes who will experience diminished performance quality when exposed to the Demeaning Coaching Technique or Condition, and accordingly, devise a coaching methodology more akin to the Positive Reinforcement Coaching Approach for those athletes. On the other hand, for players that score low on Agreeableness, the coach may want to try using the Demeaning Coaching Approach.

### EXAMPLES

The present study examined three different coaching approaches and techniques: the Positive Reinforcing Coaching Technique that is characterized by the positive encouragement suggested by Callahan's Players' Coach, the Demeaning or Disciplinarian Coaching Technique that is characterized by instilling fear through belittling players and is comparable to Callahan's Disciplinarian Manager, and a Mechanically Instructional Approach that can be described as only offering functional guidance to improve performance. The study examined each coaching approach's effect on the athletic performance of varsity-level college athletes whose personality profiles had been measured using the Five Factor Model of Personality (Costa & McCrae, 1992). This model measures personality across the dimensions of Neuroticism, Extraversion, Openness to Experience, Agreeableness, and Conscientiousness.

The Positive Reinforcing Coaching Condition solicits peak performance with positive remarks. For this reason, it is hypothesized that the athletes exposed to the Positive Reinforcing Coaching Condition will perform better than the athletes exposed to the other Coaching Conditions.

Next, Neuroticism is often associated with anxiety, discomfort, and stress; therefore, it is hypothesized that athletes high in Neuroticism will perform best when exposed to the Positive Reinforcing Coaching Condition and worst when exposed to the Demeaning Coaching Condition.

Similarly, Agreeableness is characterized by a desire to please others and is associated with a convincible demeanor. For these reasons, it is hypothesized that athletes high in Agreeableness will perform best when exposed to the Positive Reinforcing Coaching Condition and worst with the Demeaning Coaching Condition.

Conscientiousness can be described as paying meticulous attention to detail and as maintaining very high personal standards. Thus, it is hypothesized that athletes high in Conscientiousness will perform best when exposed to the Demeaning Coaching Condition because they are most likely accustomed to critical analyses of their performances.

Finally, Extraversion is characterized by a desire to socialize and interact with other people. It is hypothesized that players high in Extraversion will perform best in the Demeaning Coaching Condition because they will experience little angst from a single coach's negative interpretation of their athletic performance.

Participants included 60 male students of Harvard University. All participants were recruited male varsity athletes from Harvard University's assorted Division I-AA teams ranging from Football to Water Polo. They included athletes from 18 to 23 years in age and they varied by ethnicity, race, and religion.

Materials

The NEO-FFI (Five Factor Inventory) Personality Test (Costa & McCrae, 1992) was administered as an attachment to an email (See Appendix A). This self-report instrument tested five personality traits: Neuroticism, Extraversion, Openness, Agreeableness, and Conscientiousness with 60 questions that can be answered with: strongly disagree (SD), disagree (D), neutral (N), agree (A), to strongly agree (SA).

The Verbal Affect Measurement Scale (Bond & Lader, 1974) assessed the athletes' mood and was administered twice: after their ten-minute warm up and after their second set of fifteen free throws. This scale measured subjects' current mood across seven different dimensions: Irritability, Depression, Anxiety, Relaxation, Happiness, Drowsiness, and Alertness, on a scale from 0 to 100.

The Follow-Up Questionnaire probed into the subjective effect of the coach's motivational technique and its effect on the athlete's post experiment confidence level by asking questions related to confidence level, mood, et al.

A set of videos were produced specifically for this study to simulate each of the three motivational coaching conditions test in the experiment. Each DVD was between 36 seconds and 72 seconds in length.

A portable Spalding® basketball hoop that matched the National Basketball Association's regulation height of ten feet served as the free throw shooting apparatus for the participants. The athletes shot free throws with two regulation size, pure leather, Spalding® basketballs. The experimenter recorded the each athlete's number of successful free throws on a Microsoft Excel Spreadsheet.

Procedure

The experimenter recruited the participants with personal emails. The email offered the athletes an opportunity to participate in a Free Throw Shooting Competition and compete for a $100 Gift Certificate to a retailer of sporting goods. Prior to their participation, the athletes were required to complete the NEO-FFI Five Factor Personality Inventory by returning the completed test through email.

After completing and returning their NEO-FFI tests, the athletes indicated their preferred participation time. Finally, the experiment was run from Feb. 3, 2005 to Mar. 17, 2005.

At their scheduled participation time, each athlete completed the thirty minute experiment in a squash court. Upon arriving to the squash court, each athlete had ten minutes to “warm up” for the Free Throw Shooting Competition. In this time, the athlete could do whatever he felt was necessary to prepare for the competition. After warming up, each athlete completed the VAMS Mood Measure and then attempted fifteen free throws. The experimenter recorded the total number of free throws made.

At this point, the participants were randomly assigned to the Positive Reinforcing, Demeaning, Mechanical Techniques, or Control Conditions. The twenty subjects assigned to the Positive Reinforcing Coaching Technique watched a brief video of New Milford, N.J. Football Coach Jim Wichmann. Two Positive Reinforcing videos were used: one for subjects who successfully made less than seven free throws (45 seconds in length) and another for participants who made seven or more free throws (36 seconds in length). The twenty participants assigned to the Demeaning Coaching Technique also watched a brief video of New Milford Football Coach Jim Wichmann (36 seconds in length). The ten participants assigned to the Mechanical Technique watched a brief video of Dumont Basketball Coach Dave Cieplicki (72 seconds in length) (See Appendix B for transcripts of the videos). The subjects exposed to the Coaching Techniques stood on a black line located 2 feet from the 27″ television screen, which was located at approximately eye level to watch their respective coaching videos. Finally, the ten subjects assigned to the Control Condition had one minute to rest before completing the Free Throw Shooting Competition.

After they viewed one of the three videos or rested for one minute, the athletes then attempted fifteen additional free throws. The result of the second set of fifteen free throws was recorded by the experimenter.

Finally, the subjects completed the Verbal Affect Measurement Scale for the second time and then completed the Follow-Up Questionnaire (all save the Control group). It included inquiries concerning the coach's approach: the participant rated the coach's style/effectiveness, assessed its effect, and rated the coach's effect on his confidence. The athlete was then debriefed and received ten dollars as payment.

Results

Performance Differences by Coaching Conditions

An analysis of variance using the pre-post difference in free throws as the dependent variable and the coaching motivation condition as the between-group factor indicated that the main effect for Condition was not significant (F_{(3, 56)}=1.66, p=0.186, eta²=0.082). The means and standard deviations for each condition are listed in Table 1.

TABLE 1
Pre/Post Free Throw Differences by Condition:
Means, Standard Deviations, and N's

| Condition | Mean | Std. Deviation | N |
|---|---|---|---|
| Control | .70 | 1.636 | 10 |
| Positive | 1.60 | 1.984 | 20 |
| Mechanical | .60 | 2.633 | 10 |
| Demeaning | −.10 | 2.954 | 20 |
| Total | .72 | 2.457 | 60 |

However, a comparison of means between the Positive Reinforcing and Demeaning Coaching Conditions indicated a significant difference, with the Positive Reinforcing Condition performing better (t(38)=2.136, p=0.04). In addition, the number of subjects who improved or maintained their performance in the Positive Reinforcing Coaching Condition was significantly greater than the number of subjects who improved or maintained performance in the Demeaning Coaching Condition (χ²=5.59, p=0.02, phi=0.37) (See Table 2).

TABLE 2
Increase/Decrease in Post Free Throws:
Positive vs. Demeaning Conditions

| | Less Free | Same/More Free | |
|---|---|---|---|
| | Throws Made | Throws Made | Totals |
| Positive | 3 | 17 | 20 |
| Demeaning | 10 | 10 | 20 |
| Totals | 13 | 27 | 40 |

Performance Differences by Coaching Technique/Condition and Personality Factor

ANOVAs were conducted on pre-post free throw differences using coaching style and high and low levels of each of the Five Factor personality variables (determined by median split) as the between group factors.

Extraversion

An analysis of variance on pre-post free throw differences using coaching conditions and high extraversion (n=27, mean=38.26, SD=2.7) and low extraversion (n=33, mean=27.94, SD=4.33) groups based on median split determined that the coaching condition approached significance (F_{(3, 56)}=2.342, p=0.084, eta²=0.119). However, the level of extraversion was not significant (F_{(3, 56)}=1.334, p=0.253, eta²=0.025) and the interaction between coaching condition and extraversion was not significant (F_{(3, 56)}=1.81, p=0.157, eta²=0.095).

Openness to Experience

An analysis of variance on pre-post free throw differences using coaching conditions and high openness to experience (n=32, mean=31.63, SD=4.22) and low openness to experience (n=28, mean=31.63, SD=3.22) groups based on median split determined that the coaching condition was not significant (F_{(3, 56)}=1.436, p=0.243, eta²=0.077). Furthermore, the level of openness to experience was not significant (F_{(3, 56)}=0.037, p=0.847, eta²=0.001) and the interaction between coaching condition and openness to experience was not significant either (F_{(3, 56)}=0.273, p=0.845, eta²=0.015).

Neuroticism

An analysis of variance on pre-post free throw differences using coaching conditions and high neuroticism (n=30, mean=22, SD=5.2) and low neuroticism (n=30, mean=10.9, SD=3.1) groups based on median split determined that there was not significant main effect for coaching condition (F_{(3, 56)}=1.865, p=0.147, eta²=0.097) or for level of neuroticism (F_{(3, 56)}=0.105, p=0.75, eta²=0.002). Furthermore, there was not a significant interaction between coaching condition and neuroticism (F_{(3, 56)}=1.975, p=0.129, eta²=0.102) (See FIG. 1).

Agreeableness

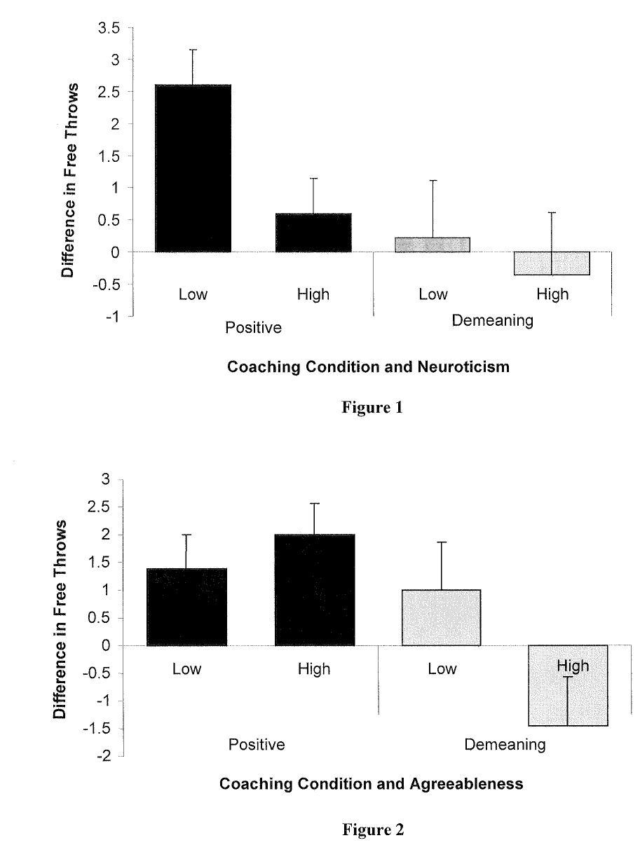

An analysis of variance on pre-post free throw differences using coaching conditions and high agreeableness (n=31, mean=35.1, SD=2.2) and low agreeableness (n=29, mean=26.7, SD=4.2) groups based on median split determined that there was a significant main effect for coaching condition (F(3, 56)=3.186, p=0.03, eta2=0.155). Conversely, the level of agreeableness was not significant (F(3, 56)=0.853, p=0.36, eta2=0.016). However, the interaction between coaching condition and agreeableness was significant (F_{(3, 56)}=3.359, p=0.026, eta₂=0.162) (See FIG. 2).

Conscientiousness

An analysis of variance on pre-post free throw differences using coaching conditions and high openness to experience (n=30, mean=38.2, SD=3.7) and low openness to experience (n=30, mean=25.4, SD=5.67) groups based on median split determined that the coaching condition was not significant (F_{(3, 56)}=1.568, p=0.208, eta²=0.083). Furthermore, the level of extraversion was not significant (F_{(3, 56)}=1.213, p=0.276, eta²=0.023) and the interaction between coaching condition and extraversion was not significant either (F_{(3.56)}=0.332, p=0.802, eta²=0.019).

Coaching Conditions' Effect on Mood

An analysis of variance using the pre-post difference in mood (Irritable, Depressed, Anxious, Relaxed, Happy, Drowsy, and Alert) as the dependent variable and the coaching condition as the between-group factor indicated that the coaching condition did not result in any significant change in mood (See Table 3).

TABLE 3
Coaching Conditions' Pre-Post Effect on Mood

| | Pre-Post | | | |
|---|---|---|---|---|
| Mood Factor | Change | F | df | p |
| Irritable | .85 | 1.682 | (3, 55) | .182 |
| Depressed | .78 | .619 | (3, 55) | .606 |
| Anxious | −.39 | .496 | (3, 55) | .687 |
| Relaxed | −.61 | .820 | (3, 55) | .488 |
| Happy | −.61 | 1.258 | (3, 55) | .298 |
| Drowsy | −.76 | .846 | (3, 55) | .475 |
| Alert | .61 | .595 | (3, 55) | .621 |

Coaching Conditions' Effect on Confidence

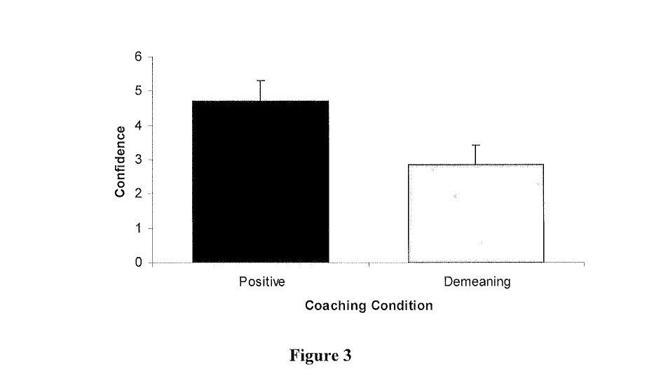

An analysis of variance using levels of post confidence as the dependent variable and the coaching condition as the between-group factor indicated that the main effect for condition approached significance (F(2,47)=2.724, p=0.076, eta₂=0.104). However, a comparison of means between the positive reinforcing and demeaning coaching conditions indicated a significant difference, with the Positive Reinforcing Coaching Condition feeling more confident (t(38)=2.225, p=0.032) (See FIG. 3).

Qualitative Responses to Coaching Conditions

Furthermore, the number of subjects who qualitatively reported Improved, Diminished, or No Effect on their Post Experiment Confidence Levels varied significantly by coaching condition χ²=15.747, p=0.0034, φ_{c}=0.481) (See Table 4).

TABLE 4
Qualitative Responses to Coaching Conditions:
Effect on Confidence

| | Improved | Diminished | No Effect | Totals |
|---|---|---|---|---|
| Positive | 13 | 0 | 2 | 15 |
| Demeaning | 2 | 6 | 5 | 13 |
| Mechanical | 3 | 1 | 2 | 6 |
| Totals | 18 | 7 | 9 | 34 |

In addition, the number of subjects who qualitatively reported the coaches' effectiveness as Effective and Improved, Ineffective and Harmful, or as Without an Effect varied significantly by coaching condition as well (χ²=18.81, p<0.001, φ_{c}=0.452) (See Table 5).

TABLE 5
Qualitative Responses to Coaching Conditions:
Effectiveness of Coach

| | Effective and | Ineffective and | Without an | |
|---|---|---|---|---|
| | Improved | Harmful | Effect | Totals |
| Positive | 15 | 3 | 0 | 18 |
| Demeaning | 3 | 13 | 4 | 20 |
| Mechanical | 5 | 2 | 1 | 8 |
| Totals | 23 | 18 | 5 | 46 |

Confidence Differences by Coaching Condition and Personality Factor

ANOVAs were conducted on confidence differences using coaching condition and high and low levels of each of the Five Factor personality variables (determined by median split) as the between group factors. The interaction between coaching condition and extraversion was not a significant predictor of confidence (F(2,47)=1.136, p=0.279, eta₂=0.056). Next, the interaction between coaching condition and openness to experience was not a significant predictor of confidence (F_{(2,47)}=0.336, p=0.637, eta²=0.02). Furthermore, the interaction between coaching condition and conscientiousness was not a significant predictor of confidence (F_{(2,47)}=0.183, p=0.316, eta²=0.051). Then, the interaction between coaching condition and agreeableness was not a significant predictor of confidence (F_{(2,47)}=0.695, p=0.504, eta²=0.031). Finally, the interaction between coaching condition and conscientiousness approaches significance as a predictor of confidence (F_{(2,47)}=2.651, p=0.082, eta²=0.108).

The above study provides evidence for three significant findings: the Positive Reinforcing Coaching Technique/Condition was unilaterally more effective than the Demeaning Technique/Coaching Condition; Agreeableness was the primary personality trait that predicted athletes' performance in the two conditions; and there was a significant difference in Post Experiment Confidence between the two coaching conditions. First, exposure to the Positive Reinforcing Coaching Condition resulted in a performance improvement for 17 of 20 athletes. Furthermore, the mean performance improvement in free throw shooting for those exposed to the Positive Coaching Condition was 1.6 free throws. Conversely, exposure to the Demeaning Coaching Condition resulted in a performance improvement for only 10 of 20 athletes. Moreover, the mean change in performance for those athletes exposed to the Demeaning Condition was −0.1 free throws. Thus, the Positive Reinforcing Coaching Condition was unilaterally more effective than the Demeaning Coaching Condition in two significant ways: it resulted in a performance improvement for a larger number of athletes than the Demeaning Coaching Condition while it also resulted in an overall performance improvement by 1.6 free throws.

Second, the only personality factor that served as an accurate predictor of athletes' performance in the Positive Reinforcing Coaching Condition and the Demeaning Coaching Condition was Agreeableness. Participants with Agreeableness scores over 32 (the median) were classified in the High Agreeableness Group and participants with Agreeableness scores under 32 were classified in the Low Agreeableness Group. When exposed to the Positive Reinforcing Coaching Condition, athletes classified in the Low Agreeableness Group improved their free throw performance by an average of 1.4 shots. Similarly, the Low Agreeableness Group improved their free throw performance by an average of one shot when the athletes were exposed to the Demeaning Coaching Condition. Most importantly, when exposed to the Positive Reinforcing Coaching Condition, the High Agreeableness Group improved their performance by an average of two shots. Conversely, when the High Agreeableness Group was exposed to the Demeaning Coaching Condition, the athletes' performance decreased by an average of −1.4 free throws. Consequently, exposure to either Coaching Condition had little effect on those athletes low in Agreeableness; however, athletes high in Agreeableness experience a drastic performance improvement when exposed to the Positive Reinforcing Condition (two free throw average improvement) while they experienced a substantial decline in performance quality (−1.4 free throw average) when exposed to the Demeaning Coaching Condition.

In addition, athletes' responses to the Positive Reinforcing Coaching Condition and the Demeaning Coaching Condition appeared not to have been influenced by the other four personality factors of the NEO-FFI Personality Test: Extraversion, Openness to Experience, Conscientiousness, and Neuroticism, at least statistically. The hypotheses concerning interaction of coaching approach and these personality factors were not statistically confirmed by the study. However, although Neuroticism did not significantly predict athletes' response to the coaching conditions as predicted, athletes who scored low in Neuroticism and were exposed to the Positive Reinforcing Coaching Condition experienced a performance improvement average of 2.6 free throws. Alternatively, when exposed to the Demeaning Coaching Condition, athletes low in Neuroticism experienced a performance improvement average of only 0.3 free throws. Therefore, Neuroticism or a related personality trait may have significant correlation with the athlete's performance in response to coaching techniques applied.

Third, there was a significant difference in Post Experiment Confidence between the Positive Reinforcing Coaching Condition and Demeaning Coaching Condition. Athletes exposed to the Positive Reinforcing Coaching Condition reported a Post Experiment Confidence average of 4.7. In contrast, athletes exposed to the Demeaning Coaching Condition reported a Post Experiment Confidence average of 2.9. This difference in Post Experiment Confidence applied to all athletes regardless of personality differences.

Most importantly, the Follow-Up Questionnaire offered the athletes an opportunity to qualitatively evaluate the coaches' influence on their confidence as well as the coaches' overall effectiveness. Fifteen of the twenty athletes who were exposed to the Positive Reinforcing Coaching Condition described the coach's effect on confidence: thirteen claimed the coach improved their confidence, none reported diminished confidence, and two claimed that the coach had no effect on their confidence. Conversely, thirteen of the twenty athletes who were exposed to the Demeaning Coaching Condition reported the coach's effect on confidence: two claimed the coach improved their confidence, six reported diminished confidence, and five believed that the coach had no effect on their confidence.

Furthermore, the athletes described the overall effectiveness of the coaches in the Follow-Up Questionnaire as well. Eighteen of the twenty athletes who were exposed to the Positive Reinforcing Coaching Condition described the coach's overall effectiveness: fifteen reported that the coach was effective and improved their performances, three claimed the coach was ineffective and actually harmed their performances, while none believed that the coach had no effect on performance. Alternatively, all twenty of the athletes who were exposed to the Demeaning Coaching Condition described the coach's overall effectiveness: three reported that the coach was effective and improved their performances, thirteen believed the coach was ineffective and actually harmed their performances, while four claimed that the coach had no effect.

Finally, the Positive Reinforcing Coaching Condition and the Demeaning Coaching Conditions had little influence on Post Experiment Mood Factors including Irritability, Depression, Anxiety, Relaxation, Happiness, or Drowsiness.

Analysis of Coaching Conditions: Experimental Observations

Each of the coaching conditions produced different physical and verbal responses from the participants during the experiment. The athletes who watched the Mechanical Instruction video had a relaxed stance and often mimicked the coach's free throw shooting technique. After watching the video, they then approached the free throw line intent on following the free throw shooting rules prescribed by the coach. None of the athletes exposed to the Mechanical Coaching Condition responded verbally.

Similarly, athletes often physically responded to the Positive Reinforcing Coaching Condition by standing comfortably, placing their hands on their nips, and by nodding their heads. After watching the video, no athletes responded verbally to the Positive Reinforcing Coaching Condition either.

Conversely, the athletes' responses to the Demeaning Coaching Condition were significantly different. While watching the video, many subjects were physically defensive. For example, they often stood with their arms crossed over their chests, arms behind their back in the proper “attention” military position, rocked their weight from one foot to the other, tilted their head back and raised their chins at the television, and many emitted a nervous laughter as the video ended. After watching the video, many athletes looked distressed, hurt, and anxious. In fact, one athlete took off his shirt after watching the video and was visibly irritated.

Analysis of Coaching Conditions. Follow-Up Questionnaire

The athletes had an opportunity to offer their own interpretation of the Coaching Conditions in the Follow-Up Questionnaire. Many athletes exposed to the Positive Reinforcing Coaching Condition indicated that the coach was effective. On the other hand, some athletes believed that the coach's approach was juvenile and would have little effect on their performances: “He would be good for grade school kids,” and “I didn't think it would affect me at all.”

Similarly, some athletes exposed to the Demeaning Coaching Condition believed the coach was ineffective: “He was not very effective. His methods included a lot of yelling and insults that were not constructive,” “Overall effectiveness was probably low because he didn't tell what to do, only what I did wrong,” “Not very effective. I was initially more motivated to perform well, and then thoughts started creeping into my head after my first miss,” “The negative reinforcement made me want to perform better but made me too irritable to do so . . . It made me self conscious . . . I was unable to forget the fact that I might suck,” “Degrading coaching techniques don't work with me,” and “It affected me negatively, it sounded like my dad and distracted me . . . at first, I wanted to prove the guy wrong, but after I missed a few shots, I got flustered and rushed . . . he got in my head . . . I let all that negative energy rush my shots and I lost focus.”

While these athletes were negatively influenced by the Demeaning Coaching Condition, other athletes argued that the coach was actually effective: “He was very effective . . . I felt like I needed to perform,” “I wanted to prove him wrong,” “He made me want to do better and make more baskets . . . he actually motivated me,” “The coach helped me focus and want to prove him wrong, overall he was pretty effective but I respond to the type of motivator who is in your face who is in your face telling you that you can't do it,” and “I realized I could be a little more focused.”

Other athletes seemed relatively apathetic when exposed to the Demeaning Coaching Condition because they were accustomed to demeaning coaches: “I'm used to having coaches yell at me, so I'm kind of numb to it,” “I tend not to listen to coaches,” and “I do not care about coaches other than their ability to allot playing time.” Conversely, the Demeaning Coaching Condition forced some athletes to recall painful coaching experiences from the past.

Coaching Implications

Generally, most athletes will achieve peak performance when exposed to the Positive Reinforcing Coaching Approach. The results of this study confirmed that the Positive Reinforcing Condition is generally most effective: 17 of 20 athletes improved their free throw shooting performances by an average of 1.6 free throws. In comparison, only ten athletes improved their free throw shooting performance with the average performance decreasing by −0.1 free throws when exposed to the Demeaning Coaching Condition. Therefore, the coaching program provided by the present invention, may incorporate a bias towards such approach/technique. In one feature, the default recommendation for an individual comprises positive reinforcement coaching techniques.

Although most athletes experience improved performance when exposed to the Positive Reinforcing Coaching Condition, those most seriously affected are high in Agreeableness. The athletes high in Agreeableness improved their free throw shooting performances by an average of two shots when exposed to the Positive Reinforcing Coaching Condition. In contrast, athletes high in Agreeableness experienced a −1.4 free throw decrease in performance quality when exposed to the Demeaning Coaching Condition. This is a significant difference between coaching conditions that is responsible for a large fluctuation in athletic performance.

Agreeable individuals are generally eager to please others and are often easily persuaded to concur with others' perspectives. Athletes high in Agreeableness experience an intense desire to please their coaches and often are persuaded by their positive or demeaning personal comments; therefore, these individuals naturally experience significantly improved performance when exposed to the Positive Reinforcing Condition and significantly diminished performance after exposure to the Demeaning Coaching Condition.

Furthermore, athletes' confidence is improved when exposed to the Positive Reinforcing Coaching Condition. According to their own reports in the Follow-Up Questionnaire, athletes' confidence was significantly higher when exposed to the Positive Reinforcing Coaching Condition (4.7) than when they were exposed to the Demeaning Coaching Condition (2.9). This finding applied to all athletes, regardless of their individual personalities. Thus, the Positive Reinforcing Coaching Condition developed greater confidence in all athletes.

At this point, it would seem logical for coaches to employ a Positive Reinforcing Coaching Approach for all athletes in an attempt to solicit peak performance and improved confidence. Although this strategy is effective for most athletes, there exists a portion of the athletic population that believes the Positive Reinforcing Coaching Approach is juvenile and prefers the Demeaning Coaching Approach. It is important to highlight that ten athletes out of the twenty who were exposed to the Demeaning Coaching Condition did in fact improve their free throw shooting performance. These athletes were mostly low in Agreeableness and openly supported the Demeaning Coaching Approach in their Follow-Up Questionnaires.

Accordingly, coaches who truly hope to solicit peak performance from each athlete must apply an Individualized Coaching Approach to each athlete. Most athletes prefer the Positive Reinforcing Coaching Approach and it is perfectly acceptable to use this technique for those players. At the same time, others may demand a Demeaning Coaching Approach. The coach need to clearly identify which technique will solicit peak performance from each athlete and effectively apply the techniques to both groups at the same time.

Unfortunately, this solution requires a dynamic coach who knows his athletes well, spends time with them, and is involved in their personal lives. Many coaches experience difficulties establishing these friendly relationships with players. However, according to the present invention, administering a personality test provides an efficient way to determine levels of Agreeableness, which then in turn serves as the foundation of the coach-player interaction. By simply administering this test and determining levels of Agreeableness, a coach may quickly identify the athletes who will likely experience diminished performance quality when exposed to the Demeaning Coaching Condition. Particularly, athletes high in Agreeableness are too often exposed to the Demeaning Coaching Condition, experience severely reduced athletic performance, and lose interest in the particular sport.

Finally, the results of this study suggest an alternative method to improve athletic performance: the Individualized Coaching Approach. By employing this approach, coaches is equipped to solicit peak performance from all athletes based on their individual coaching preference. Most importantly, if coaches adopt this approach, they will no longer reduce the quality of performance in a number of their athletes by blindly applying one coaching approach. Instead, they will foster an environment conducive to athletic success for all athletes regardless of their preference in coaching approach.

The programs for providing Individualized Coaching Approach can be further fine-tuned by taking into account population-specific factors in correlating personal traits with coaching techniques. To determine if such factors exist, studies can be extended to study female athletes, athletes of different age groups and or education background (grade school, middle school, high school, college, and professional), athletes from different regions of the country, an analysis of ethnic and racial effects, an analysis of parental influence, and finally an assessment of coaches' personalities. As a result, the programs of the present invention may factor in age, gender, ethnicity, race, education level, national origin, religion, sexual orientation, and other considerations when recommending coaching techniques for a trainee.

Business Method in Accordance with the Invention

The present invention provides printed programs, e.g., books, where the Individualized Coaching Approach is explained. The program includes personality test(s) on one or more personality traits, such as the NEO-FFI Personality Test found in Appendix A. The test can be used by the reader to test a trainee, e.g., an athlete. The program may also include a scoring system. The scoring system may include a correlation table that correlates at least one score from the test to a particular coaching or motivational technique. For example, the personality traits may focus on agreeableness.

In one embodiment, the tested personality traits may further include neuroticism, extraversion, openness to experience, and conscientiousness. According to the correlation table, a relatively high score in agreeableness will generate a recommendation of a positive reinforcement coaching technique, while a relatively low score on agreeableness generates a recommendation of a demeaning or disciplinarian coaching technique. This table may also be stored on a computer server remote from the end user such that access to the table may be controlled, e.g., by a password. Specific training methods and protocols encompassed by both (and, optionally, other) coaching techniques are explained in the program. The program may include examples, tips or other helpful materials regarding any number of training or motivational coaching protocols and techniques, for example, video examples similar to the one described above in the study.

Of course, the test and scoring system can all be included in a software program stored in an electronic memory comprising executable commands to calculate the score and to reference the table and arrive at the recommendation. The medium of the electronic memory, e.g., a CD/DVD can be included as part of the program. The CD/DVD can further provide controlled access to a web site.

On-Line Business:

web site includes
Brief descriptions of
   Present inventor's background
   Inspiration
   Study results
   Conclusions
   Practical applications
   Links
   Community Development
   Recommended reading
   Interviews with top coaches and players
   Description and contact info for personal and team consulting
Log in section for those who have purchased the book
   Requires CD/DVD or a restricted piece of information such as a password to access this section.
   Provides exclusive information
      Personal and team accounts for coaches to have their players take online personality tests, code them, and produce/save valuable results—and practical coaching considerations for the player and team. Moreover, it would provide graphs, trends, and plot progress/changes over time for players, teams, and coaches.
      Descriptions of ongoing research
         More demographics
         All ages
         Male/Female
         All sports
         All areas of the country
         Varying education etc.
   Consulting business targeting
      Professional teams in all sports
      College teams in all sports
      Male/female

While the present invention has been particularly shown and described with reference to the description disclosed herein and as illustrated in the drawings, it is not confined to the details set forth and this invention is intended to cover any modifications and changes as may come within the scope and spirit of the claims. Further, the words “condition,” “approach” and “technique” are often used interchangeably herein. Contents of all references described in the specification including those in the Appendices are incorporated herein by reference.

### Appendix A

### NEO-FFI Personality Test

Answer the following questions in the Answer Key provided in the other attachment. Answer the questions with one of the five options.

### SD=Strongly Disagree

### D=Disagree

### N=Neutral

### A=Agree

### SA=Strongly Agree

1. I am not a worrier.
2. I like to have a lot of people around me.
3. I don't like to waste my time daydreaming.
4. I try to be courteous to everyone I meet.
5. I keep my belongings clean and neat.
6. I often feel inferior to others.
7. I laugh easily.
8. Once I find the right way to do something, I stick to it.
9. I often get into arguments with my family and coworkers.
10. I'm pretty good about pacing myself so as to get things done in time.
11. When I'm under a great deal of stress, sometimes I feel like I'm going to pieces.
12. I don't consider myself especially “light-hearted.”
13. I am intrigued by the patterns I find in art and nature.
14. Some people think I'm selfish and egotistical.
15. I am not a very methodical person.
16. I rarely feel lonely or blue.
17. I really enjoy talking to people.
18. I believe letting students hear controversial speakers can only confuse and mislead them,
19. I would rather cooperate with others than compete with them.
20. I try to perform all the tasks assigned to me conscientiously.
21. I often feel tense and jittery.
22. I like to be where the action is.
23. Poetry has little or no effect on me.
24. I tend to be cynical and skeptical of others' intentions.
25. I have a clear set of goals and work toward them in an orderly fashion.
26. Sometimes I feel completely worthless.
27. I usually prefer to do things alone.
28. I often try new and foreign foods.
29. I believe that most people will take advantage of you if you let them.
30. I waste a lot of time before settling down to work.
31. I rarely feel fearful or anxious.
32. I often feel as if I'm bursting with energy.
33. I seldom notice the moods or feelings that different environments produce.
34. Most people I know like me.
35. I work hard to accomplish my goals.
36. I often get angry at the way people treat me.
37. I am a cheerful, high-spirited person.
38. I believe we should look to our religious authorities for decisions on moral issues.
39. Some people think of me as cold and calculating.
40. When I make a commitment, I can always be counted on to follow through.
41. Too often, when things go wrong, I get discouraged and feel like giving up.
42. I am not a cheerful optimist.
43. Sometimes when I am reading poetry or looking at a work of art, I feel a chill or wave of excitement.
44, I'm hard-headed and tough-minded in my attitudes.
45. Sometimes I'm not as dependable or reliable as I should be.
46. I am seldom sad or depressed.
47. My life is fast-paced.
48. I have little interest in speculating on the nature of the universe or the human condition.
49. I generally try to be thoughtful and considerate.
50. I am a productive person who always gets the job done.
51. I often feel helpless and want someone else to solve my problems.
52. I am a very active person.
53. I have a lot of intellectual curiosity.
54. If I don't like people, I let them know.
55. I never seem to be able to get organized.
56. At times I have been so ashamed I just wanted to hide.
57. I would rather go my own way than be a leader of others.
58. I often enjoy playing with theories or abstract ideas.
59. If necessary, I am willing to manipulate people to get what I want.
60. I strive for excellence in everything I do.
Please answer the questions from the Personality Test by typing in your response for each question next to the corresponding number. Please send this Answer Key back to the Experimenter as an attachment of an Email when it's complete.

### Appendix B

### Transcripts of the Coaches' Motivational Videos

### Positive Reinforcing Coaching Condition (Seven or More Shots Made)

“That's an incredible job out there, I'm very happy with what you did today. I'm very happy with the way you were paying attention to the details to win this competition. You're out there and you're focusing on the things you need to focus on: you're focusing on your technique, you're focusing on getting the shot off, you're focusing on spotting the back of the rim, you're focusing on your follow through. You're doing a great job of blocking out all the things you don't need to pay attention to: you don't need to be bothered with what people are saying, you don't need to be bothered with what other people are doing. Focus on what you have to do to win the competition. You're doing a great job on that and if you keep doing it the way that you're doing it, I know that you're going to win this. Ok, so we're not going to change anything, keep doing what you're doing, and everything is going to be fine. That's a great job, I'm very happy with what you're doing.”

Positive Reinforcing Coaching Condition (Fewer than Seven Shots Made)

“It just didn't go well. Don't worry about it, don't dwell on it, don't pay attention to it, control what you can. Right now you have to go in there and you have to concentrate on your technique, you have to concentrate on sighting the back of the rim, you have to concentrate on following through with it. Don't lay down, there's no reason to! You still can win this competition. Ok, I want you to go back in there and I want you to focus on what you have to, to win this, and I want you to concentrate, and I want you to block out everything that has just happened. You still can win this: Don't stop playing, don't quit! Focus and concentrate, and you'll come out fine. Don't worry about it.”

### Mechanical Instruction Condition

“Here's what you have to do when you get to the foul line. Make sure we have a straight line: elbow, knee, shoulder. When you put the ball in your hand, I don't want it touching the palm. Make sure the index finger and the middle finger, these are your guides to the rim, so when you follow through, I want these two fingers toward the rim. I want you to grab the rim on the release. So what you do is, when you go to the foul line, I want you to have some type of a plan. When you go there, dribble two, three times: as many times as you feel is necessary, to get into your rhythm. When you get to the foul line, there is a little dot on the floor. On that little dot, if you're a right handed shooter, as you are, make sure your front foot is on that dot. Get the ball in your hand, and make sure when you release the ball that you shoot towards the ceiling. There is an imaginary arch as the ball leaves your hand that is going to go into the basket: you have to be able to find that arch. I know you can do this, we've practiced this for some time now. Just continue and we're going to make it work. Just listen to me and just follow the rules I told you.”

### Demeaning Coaching Condition

“Ok All-Star, here's the problem: you're the greatest thing that ever showed up here at this University and you're losing 'cause you're horrible! You're getting up on that line and you're flying through this like it's some kind of a speed race and it's not! Your problem is: you're not focused, you're not concentrating, you're not paying attention to details, and you're trying to rip through this ‘cause you think you’ re great and you're not! You're probably the worst athlete I've ever seen in my life: you have no focus whatsoever. You gotta get up there, you gotta take your time, you gotta slow yourself down, and you have to concentrate. And the reason you're gonna lose this, is because you have an inability to do that! You're the worst athlete I've ever seen! You suck! ”

### Appendix C

### REFERENCES

Bond, A. & Lader, M. (1974). The use of analogue scales in rating subjective feelings. British Journal of Medical Psychology, 47, 211-218
Costa, P. T. & McCrae, R. R. (1992). Revised NEO Personality Inventory and NEO Five Factor Inventory Professional Manual. Odessa, Fla.: Psychological Assessment Resources.
Jones, M. V, (2003). Controlling emotions in sport. The Sport Psychologist, Vol. 17, 471-486.
Lane, Andrew & Streeter, Bernard, (2003). The effectiveness of goal setting as a strategy to improve basketball shooting performance. International Journal of Sports Psychology, Vol. 34(2), 138-150.
Lyle, John, (2002). Sports Coaching Concepts. A Framework for Coaches' Behaviour. New York, N.Y.: Routledge.
Pates, J. & Karageorghis, C. I. & Fryer, R. & Maynard I. (2003). Effects of asynchronous music on flow states and shooting performance among netball players. Psychology of Sports & Exercise, Vol. 4(4), 415-427.
Pates, J. & Maynard, Ian & Westbury, Tony (2001). An investigation into the effects of hypnosis on basketball performance. Journal of Applied Sports Psychology, Vol. 31(1) 84-102.
Phillips, Donald T (2001). Vince Lombardi on Coaching and Leadership: Run to Win. New York, N.Y.: St. Martin's Griffin.
“The Official Website of the Boston Red Sox,”<http://www.redsox.com> (cited 3 Mar. 2005).
Thelwell, Richard C. & Greenlees, lain A (2003). Developing competitive endurance performance using mental skills training. Sport Psychologist, Vol. 17(3), 318-337.
Warren, William (2002). Coaching and Motivation: A Practical Guide to Maximum Athletic Performance. Spring City, Pa.: Reedswain Publishing.

1. A coaching program comprising:
a personality test comprising questions designed to score an individual on one or more personality traits; and
a table correlating at least one score from the test to a particular coaching technique as a recommendation for the individual.

2. The program of claim 1, comprising materials printed on a tangible medium.

3. The program of claim 1 comprising materials stored in an electronic medium.

4. The program of claim 3 comprising a computer readable compact disc.

5. The program of claim 3 wherein the table is stored on a computer server remote from an end user such that access to the table can be regulated.

6. The program of claim 5 wherein the access to the table is password-controlled.

7. The program of claim 1, further comprising a software program stored in an electronic memory and comprising executable commands to calculate the at lest one score and to reference the table and to arrive at the recommendation.

8. The program of claim 1 wherein the one or more personality traits comprise agreeableness.

9. The program of claim 8 wherein the table correlates a relative high score on agreeableness with a positive reinforcement coaching technique.

10. The program of claim 8 wherein the table correlates a relative low score on agreeableness with a demeaning coaching technique.

11. The program of claim 1 wherein the one or more personality traits are selected from the group consisting of neuroticism, extraversion, openness to experience, and conscientiousness.

12. The program of claim 1 wherein a default recommendation for the individual comprises a positive reinforcement coaching technique.

13. The program of claim 1 wherein the coaching technique is designed for improving athletic performance.

14. The program of claim 1 wherein the coaching technique is designed for improving job performance.

15. The program of claim 1 wherein the program stores data related to the score and is designed to be taken over the time so that the recommended coaching technique can be updated.

16. The program of claim 1 further comprising an example of the particular coaching technique.

17. A method for devising a coaching approach for an individual, comprising the steps of:
administering a personality test to an individual;
scoring the individual on one or more personality traits; and
determining, based on the individual's score on the one or more personality traits, one or more coaching techniques for the individual.

18. The method of claim 17 wherein the one or more personality traits comprise agreeableness.

19. The method of claim 18, further comprising the step of recommending a positive reinforcement coaching technique for the individual with a relatively high score on agreeableness.

20. The method of claim 18, further comprising the step of recommending a demeaning coaching technique for the individual with a relatively low score on agreeableness.

21. The method of claim 17 wherein the one or more coaching techniques are selected from the group consisting of positive reinforcement, mechanical, and demeaning coaching techniques.

22. The method of claim 17 wherein the determining step comprises referencing a table that is stored on a computer server remote from an end user and controlling access to the table through a password.
